(19) United States
(12) Patent Application Publication
(10) Pub. No.: US 2013/0097850 A1
(43) Pub. Date: Apr. 25, 2013

(54) APPARATUS AND METHOD FOR SERVICING A TURBINE COMPONENT

(71) Applicant: Sergin Yolsal, Istanbul (TR)

(72) Inventor: Sergin Yolsal, Istanbul (TR)

(73) Assignee: GENERAL ELECTRIC COMPANY, Schenectady, NY (US)

(21) Appl. No.: 13/407,282

(22) Filed: Feb. 28, 2012

(30) Foreign Application Priority Data
Oct. 24, 2011 (TR) PT201110536KO

(51) Int. Cl. B25H 1/10; B25B 5/16; B25B 11/00; B25H 1/00

(52) U.S. Cl. 29/559; 269/329; 269/58; 269/56

(57) ABSTRACT

According to one aspect of the invention, an apparatus for servicing a turbine component is provided where the apparatus includes a bench member configured to receive the turbine component and at least one clamping device extending from the bench member to secure the turbine component. The apparatus further includes a bracket coupled to the bench member, wherein the bracket is configured to be coupled to a stand and to support the bench member and turbine component.

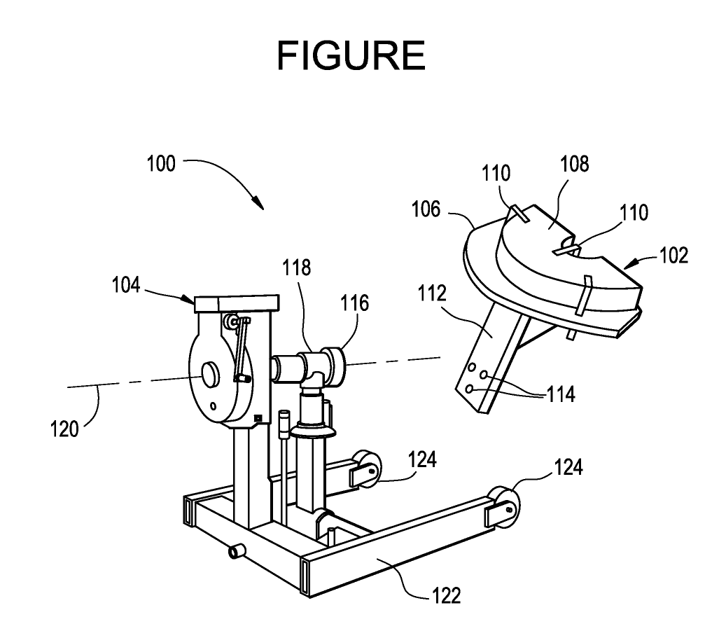

### CROSS REFERENCE TO RELATED APPLICATIONS

This application claims priority to Turkish Application No. PT 2011/10536-KO filed on Oct. 24, 2011, the entire contents of which are incorporated herein by reference.

### BACKGROUND OF THE INVENTION

The subject matter disclosed herein relates to repairing turbine components, and, more particularly, tables configured to receive turbine components during repair.

Repairing, assembling and servicing large turbine components can be an inefficient and cumbersome process due to the size and weight of the parts. In some cases, large turbine components are moved around a workspace by a forklift, crane or other machinery. The use of a forklift or crane to move the components between workspaces utilizes floor space within a repair area for maneuvering the vehicle. Further, the forklift uses additional resources for power as the vehicle requires electrical or engine power to operate. Once the component is placed on a stationary table at a workspace, the repair person often needs access to certain areas of the component which are difficult to access, which can lead to operator fatigue and reduce operator productivity.

### BRIEF DESCRIPTION OF THE INVENTION

According to one aspect of the invention, an apparatus for servicing a turbine component is provided where the apparatus includes a bench member configured to receive the turbine component and at least one clamping device extending from the bench member to secure the turbine component. The apparatus further includes a bracket coupled to the bench member, wherein the bracket is configured to be coupled to a stand and to support the bench member and turbine component.

According to another aspect of the invention, a method for servicing a turbine component is provided where the method includes placing the turbine component on a bench member and securing the turbine component to the bench member via at least one clamping device extending from the bench member, wherein the bench member is supported by a bracket coupled to a stand. The method further includes moving the stand and turbine component between areas of a workspace floor, wherein the stand and turbine component are manually moved by an operator.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a perspective view of an exemplary turbine component service apparatus and a turbine component.

The detailed description explains embodiments of the invention, together with advantages and features, by way of example with reference to the drawings.

### DETAILED DESCRIPTION OF THE INVENTION

Turbine systems, such as steam or gas turbines, include several large components that are routinely serviced and repaired. For example, a turbine system includes a diaphragm from a compressor or turbine section of the system, wherein the diaphragm is removed for service at selected time intervals. The diaphragm may be serviced due to wear and tear over time. The servicing process may take several steps, such steps for grinding and welding worn areas of the component. A workshop floor may include several service areas or cells, wherein each cell is configured for certain types of repair, such as one cell for grinding and another cell for welding. Accordingly, when servicing the turbine component, the component is moved between workshop areas depending on the service to be performed. In addition, multiple sections of the diaphragm are serviced after the component is removed from the turbine.

Referring now to the FIGURE, an exemplary turbine component service apparatus 100 is shown. The turbine component service apparatus 100 includes a bench assembly 102 and a stand 104. The bench assembly 102 is configured to be coupled to the stand 104. The bench assembly 102 includes a bench member 106 or plate, wherein a turbine component, such as a diaphragm 108, is placed on and supported by the bench assembly 102. The bench assembly 102 also includes one or more clamping devices 110 configured to secure the diaphragm 108 to the bench member 106. The clamping devices 110 are suitable devices configured to secure the diaphragm 106 as an operator maneuvers the component for servicing. The bench assembly 102 further includes a bracket 112 with holes 114 to receive bolts to enable coupling between the bench assembly 102 and the stand 104.

As depicted, the stand 104 includes a mounting hub 116 configured to couple to the bracket 112. The mounting hub 116 extends from a support 118, wherein the stand 104 and support 118 are configured to enable rotation of the bench assembly 102 and diaphragm 108 about an axis 120 of the mounting hub 116 and support 118. The support extends from a base 122 of the stand 104, wherein the base 122 includes rolling devices, such as wheels 124, configured to enable an operator to maneuver the turbine component service apparatus 100 around a workshop floor.

The exemplary stand 104 is any suitable stand configured to support heavy and large parts or components, such as a stand for supporting a diesel engine. As depicted, the bench assembly 102 and stand 104 enable movement of large turbine components between various parts of a workspace floor by a single human operator without additional equipment or machinery. The diaphragm 108 may be a whole diaphragm or a part of a diaphragm from a turbine. As depicted, the diaphragm 108 is a half diaphragm from the turbine. In embodiments, the diaphragm 108 weighs between about 400 and about 900 pounds (lbs). An exemplary diaphragm 108 weighs greater than about 400 lbs. In embodiments, the diaphragm 108 outer diameter ranges from about 30 to about 120 inches (in). The exemplary diaphragm 108 may have an outer diameter greater than about 30 inches. Further, the dimensions of the bench assembly 102 and stand 104 may be altered depending on the size and weight of the turbine component being serviced.

The depicted turbine component service apparatus 100 enables a single operator to manually maneuver the large diaphragm 108 without use of additional machinery, such as forklifts, cranes or winches, thereby saving costs while simplifying the service workspace floor. The operator may manually adjust an angle of the diaphragm 108 or manually move the component between workspace areas. By enabling rotation of the diaphragm 108 about the axis 120 by an operator, repair operations may be performed on various portions of the component without movement by the operator, thereby reducing operator fatigue. For example, the stand 104 may allow rotation and locking of the diaphragm 108 at a selected angle, such as 30, 45 or 60 degrees with respect to the floor, to enable an operator to weld and grind the component at a selected elevation and angle to reduce fatigue, thereby reducing time needed to service the component. As depicted, the turbine component service apparatus 100 enables an operator to manually move and manipulate large turbine components, such as the diaphragm 108, for servicing without using other machinery or equipment. An exemplary turbine component service apparatus 100 enables the operator to access the leading and trailing edges, as well as the inner and outer diameters, of the diaphragm 108. Further, portions of the component are grinded and welded at a selected angle and elevation to improve operator productivity, while movement of the component between workspaces is also simplified.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus for servicing a turbine component, the apparatus comprising:
a bench member configured to receive the turbine component;
at least one clamping device extending from the bench member to secure the turbine component; and
a bracket coupled to the bench member, wherein the bracket is configured to be coupled to a stand and to support the bench member and turbine component.

2. The apparatus of claim 1, comprising a plurality of clamping devices extending from the bench member.

3. The apparatus of claim 1, wherein the bracket is coupled to a bottom surface of the bench member and the at least one clamping device is configured to secure the turbine component to a top surface of the bench member.

4. The apparatus of claim 1, wherein the bench member and bracket are configured to support a turbine component weighing greater than about 400 lbs.

5. The apparatus of claim 1, wherein the turbine component comprises a diaphragm.

6. The apparatus of claim 1, wherein the turbine component comprises a diaphragm with an outer radius greater than about 30 inches.

7. The apparatus of claim 1, wherein the bench member and bracket are configured to move the turbine component angularly about an axis when the stand is coupled to and supporting the bracket.

8. The apparatus of claim 7, wherein the bench member and bracket enable angular movement of the turbine component manually by an operator.

9. The apparatus of claim 1, wherein the bench member and bracket enable manual movement of the turbine component between service areas by an operator when the stand is coupled to and supporting the bracket.

10. A method for servicing a turbine component, the method comprising:
placing the turbine component on a bench member;
securing the turbine component to the bench member via at least one clamping device extending from the bench member, wherein the bench member is supported by a bracket coupled to a stand; and
moving the stand and turbine component between areas of a workspace floor, wherein the stand and turbine component are manually moved by an operator.

11. The method of claim 10, wherein placing the turbine component comprises placing a turbine component weighing greater than about 400 lbs on the bench member.

12. The method of claim 10, wherein placing the turbine component comprises placing a diaphragm on the bench member.

13. The method of claim 12, wherein the diaphragm has an outer radius greater than about 30 inches.

14. The method of claim 10, comprising manually moving the turbine component angularly about an axis wherein the bench member and bracket are configured to pivot about the axis with the turbine component relative to the stand.

15. A turbine component service apparatus, the apparatus comprising:
a bench member configured to receive a turbine component;
a plurality of clamping devices extending from the bench member to secure the turbine component; and
a bracket coupled to the bench member and a stand, wherein the bench member and bracket enable manual movement of the turbine component by an operator when the stand is supporting the bracket.

16. The apparatus of claim 15, wherein the bench member and bracket enable manual movement of the turbine component between service areas by an operator when the stand is coupled to and supporting the bracket.

17. The apparatus of claim 15, wherein the turbine component comprises a diaphragm.

18. The apparatus of claim 15, wherein the turbine component comprises a diaphragm with an outer radius greater than about 30 inches and weighing greater than about 400 lbs.

19. The apparatus of claim 15, wherein the bench member and bracket are configured to move the turbine component angularly about an axis when the stand is coupled to and supporting the bracket.

20. The apparatus of claim 15, wherein the turbine component comprises a diaphragm weighing greater than about 400 lbs.
